(19) United States
(12) Patent Application Publication
(10) Pub. No.: US 2014/0172277 A1
(43) Pub. Date: Jun. 19, 2014

(54) ENGINE DIAGNOSTIC SYSTEM AND METHOD

(71) Applicant: CATERPILLAR INC., Peoria, IL (US)

(72) Inventor: Gregory M. Klett, Alsip, IL (US)

(73) Assignee: Caterpillar Inc., Peoria, IL (US)

(21) Appl. No.: 13/718,100

(22) Filed: Dec. 18, 2012

(51) Int. Cl. F02D 41/34

(52) U.S. Cl. CPC F02D 41/345
USPC 701/105

(57) ABSTRACT

A diagnostic method for a reciprocating internal combustion engine is disclosed. The diagnostic method includes determining a cylinder pressure relationship between a periodic or continuous pressure of a combustion chamber of the engine and a crankshaft angle of the engine for a combustion cycle including a fuel injection. The method further includes determining a heat release rate relationship between the heat release rate in the combustion chamber and the crankshaft angle as a function of the pressure relationship. The method includes estimating an end of fuel injection crankshaft angle for the combustion cycle as a function of the first derivative of the heat release rate relationship.

### TECHNICAL FIELD

The present disclosure relates generally to engine diagnostic systems and methods. Specifically, an embodiment of the present disclosure relates to an engine diagnostic system and method including estimating the end of a fuel injection.

### BACKGROUND

As a machine may be taken out of service for a period when an oil change is necessary, it is generally desirable to change the oil only when it degrades to an unacceptable operating condition. Balancing this with ensuring that the oil is able to properly lubricate engine parts can be challenging. One of the factors that may be used to determine how quickly engine oil degrades is the quantity of fuel that leaks from the combustion chamber to the oil reservoir. The capability of accurately estimating the end of fuel injections, along with the geometry of the piston bowl and other combustion characteristics, can aid in determining oil leakage.

U.S. Pat. No. 6,994,077 to Kobayashi et al. discloses cylinders of a diesel engine provided with cylinder pressure sensors for detecting combustion chamber pressures. An electronic control unit of the engine selects optimum combustion parameters in accordance with a fuel injection mode of fuel injectors of the engine and a combustion mode determined by the amount of EGR gas supplied from the EGR valve from among a plurality of types of combustion parameters expressing the combustion state of the engine calculated based on the cylinder pressure sensor output and feedback controls the fuel injection amount and fuel injection timing so that the values of the combustion parameters match target values determined in accordance with the engine operating conditions. Due to this, the engine combustion state is controlled to the optimum state at all times regardless of the fuel injection mode or combustion mode.

### SUMMARY

In one aspect, a diagnostic method for a reciprocating internal combustion engine is disclosed. The diagnostic method includes determining cylinder pressure as a function of crankshaft angle in a combustion chamber of the engine during a combustion cycle. The combustion cycle includes a fuel injection event, The method further includes determining a heat release rate as a function of crankshaft angle in the combustion chamber during the combustion cycle.

The heat release rate is determined from the cylinder pressure at a given crankshaft angle. The method further includes estimating a crankshaft angle associated with an end of the fuel injection event as the crankshaft angle associated with when the first derivative of the heat release rate in relation to the crankshaft angle crosses zero and remains negative for a predetermined crankshaft angle duration.

In another aspect, a diagnostic system for a reciprocating internal combustion engine is disclosed. The system includes a crankshaft, at least one cylinder assembly, and a controller. The crankshaft includes a crankshaft angle. The at least one cylinder assembly includes a cylinder, a piston, a combustion chamber, a cylinder pressure sensor, and a fuel injector. The piston is slidingly disposed in the cylinder and operably and rotatably connected to the crankshaft. The combustion chamber is defined by the cylinder and the piston. The cylinder pressure sensor is disposed in the combustion chamber and is operable to generate a periodic or continuous cylinder pressure signal indicative of a pressure in the combustion chamber. The fuel injector is configured to generate a fuel injection event in the combustion chamber during a combustion cycle of the engine as a function of a fuel injection signal indicative of the duration and timing of one or more fuel injections during the combustion cycle. The controller is configured to generate the fuel injection signal, determine a heat release rate as a function of crankshaft angle in the combustion chamber during the combustion cycle from the cylinder pressure signal and the crankshaft position signal during the combustion cycle, and estimate a crankshaft angle associated with an end of the fuel injection event from the first derivative of the heat release rate in relation to the crankshaft angle.

### BRIEF DESCRIPTION OF THE DRAWINGS

FIG. 1 is a schematic illustration of an exemplary engine diagnostic system.

FIG. 2 is a schematic illustration of a cutaway of an exemplary cylinder assembly that may be used in conjunction with the engine diagnostic system of FIG. 1.

FIG. 3 is an exemplary plot of a heat release rate in a combustion chamber of an engine in relation to a crankshaft angle of the engine.

FIG. 4 is an exemplary plot of a first derivative of a heat release rate in a combustion chamber of an engine in relation to a crankshaft angle of the engine.

FIG. 5 is an exemplary flowchart of an engine diagnostic method.

### DETAILED DESCRIPTION

Reference will now be made in detail to specific embodiments or features, examples of which are illustrated in the accompanying drawings. Generally, corresponding or similar reference numbers will be used, when possible, throughout the drawings to refer to the same or corresponding parts.

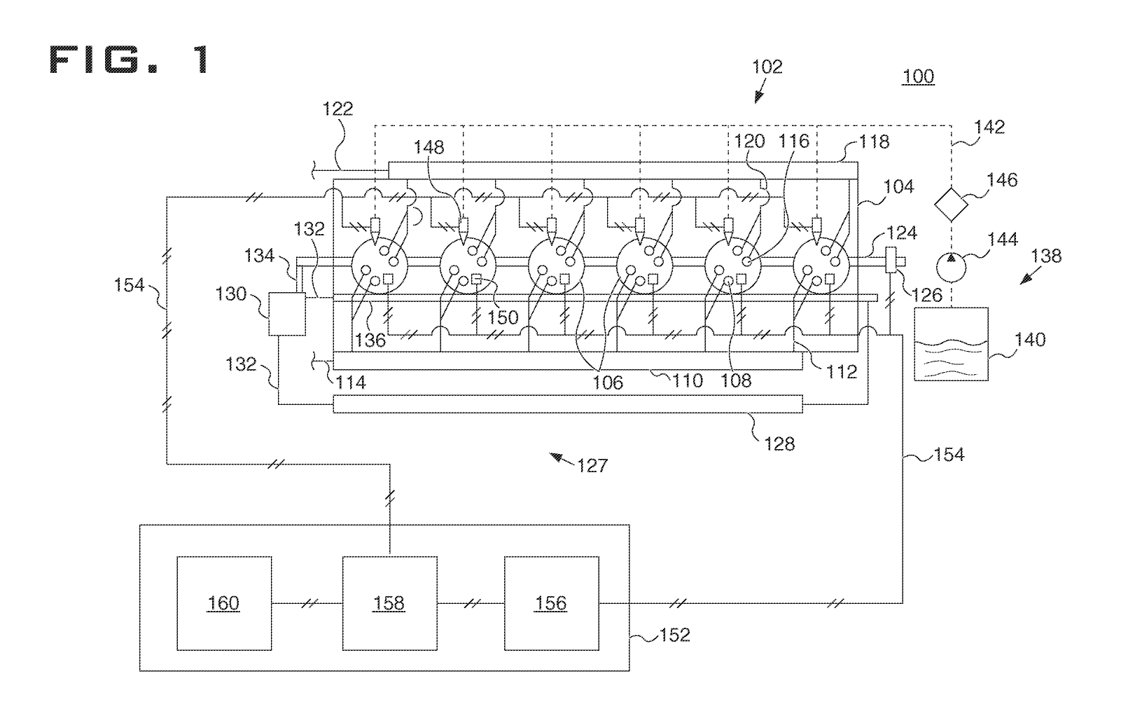

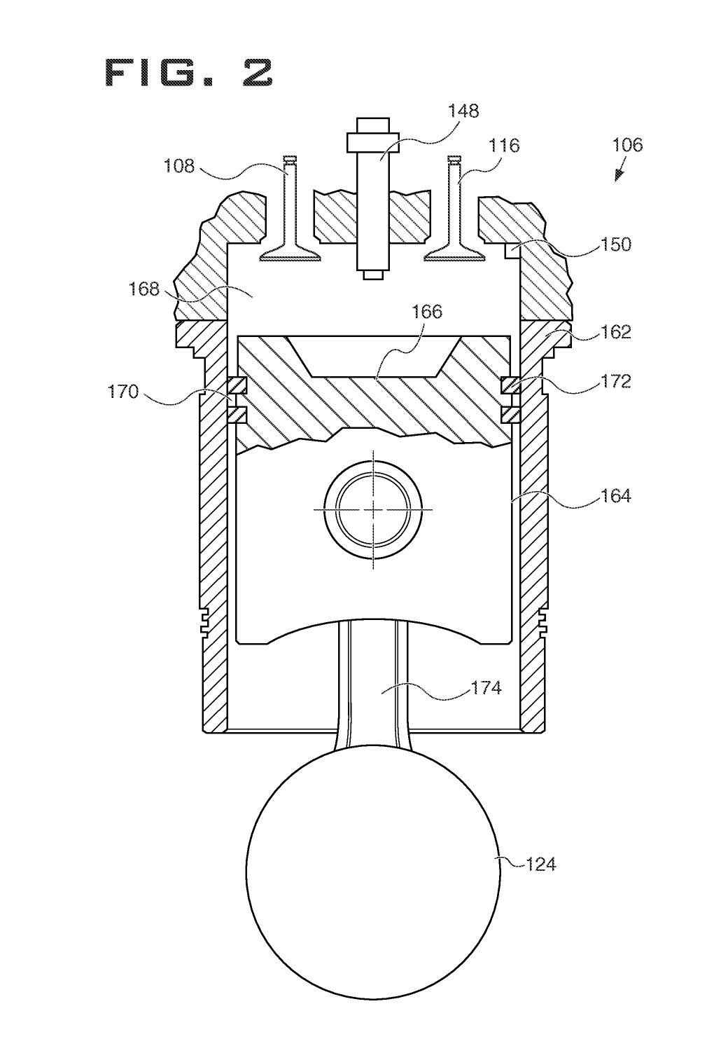

Referring now to FIG. 1, a reciprocating internal combustion engine diagnostic system 100 is illustrated. The system 100 includes a reciprocating internal combustion engine 102. In one embodiment, the engine 102 includes a diesel engine that combusts a mixture of air and diesel fuel. In alternative embodiments the engine 102 may include a gasoline engine or any other reciprocating internal combustion engine including a fuel injection device, such as a fuel injector 148, configured to generate a fuel injection event including one or more fuel injections into a combustion chamber 168 (shown in relation to FIG. 2) during a combustion cycle as would be known in the art.

The illustrated engine 102 includes an engine block 104 in which a plurality of cylinder assemblies 106 are disposed. Although six cylinder assemblies 106 are shown in an inline configuration, in other embodiments fewer or more cylinder assemblies may be included or another configuration such as a V-configuration may be employed. The system 100 can be utilized in any suitable application including mobile applications such as motor vehicles, work machines, locomotives or marine engines, and in stationary applications such as electrical power generators.

Each cylinder assembly 106 includes one or more intake valves 108, to supply air that is combusted with the fuel in the cylinder assemblies 106. A hollow runner or intake manifold 110 can be formed in or attached to the engine block 104 such that it extends over or proximate to each of the cylinder assemblies 106. The intake manifold 110 can communicate with an intake line 114 that directs air to the engine 102. Fluid communication between the intake manifold 110 and the cylinder assemblies 106 can be established by a plurality of intake runners 112 extending from the intake manifold 110. The intake valves 108 can open and close to selectively introduce the intake air from the intake manifold 110 to the cylinder assemblies 106. While the illustrated embodiment depicts the intake valves 108 at the top of the cylinder assemblies 106, in other embodiments the intake valves may be placed at other locations such as through a sidewall of the cylinder assemblies 106.

To direct exhaust gas from the cylinder assemblies 106 after combustion events, each cylinder assembly 106 includes one or more exhaust valves 116. An exhaust manifold 118 communicating with an exhaust line 122 may also be disposed in or proximate to the engine block 104. The exhaust manifold 118 can receive exhaust gasses by selective opening and closing of the one or more exhaust valves 116 associated with each cylinder assembly 106. The exhaust manifold 118 can communicate with the cylinder assemblies 106 through exhaust runners 120 extending from the exhaust manifold 118.

The valves 108, 116 may be actuated by a camshaft (not shown) including a plurality of eccentric lobes disposed along its length that, as the camshaft rotates, cause the valves 108, 116 to displace or move up and down in an alternating manner with respect to the cylinder assemblies 106. Movement of the valves 108, 116 can seal and unseal ports leading into the cylinder assemblies. The placement or configuration of the lobes along the camshaft determines the gas flow through the engine 102.

As is known in the art, other methods exist for implementing valve 108, 116 and/or intake air and exhaust timing such as electronic, electrical and/or hydraulic actuators acting on the individual valve stems and the like. In some two stroke combustion engines, the intake valves may be replaced with a port which is opened and closed by the moving of a piston 164 (shown in relation to FIG. 2) within the cylinder assembly 106.

Referring to FIG. 2, a schematic cut-away view of an exemplary embodiment of a cylinder assembly 106 is illustrated. The cylinder assembly 106 includes a cylinder 162, and a piston 164 slidingly disposed in the cylinder 162. The cylinder 162 and piston 164 define a combustion chamber 168 and a leakage channel 170. The piston 164 includes a bowl 166 and rings 172. A cylinder pressure sensor 150, configured to generate a cylinder pressure signal indicative of the pressure in the combustion chamber 168, can be disposed in the combustion chamber 168, as is known in the art. A rod 174 operably and rotatably couples the piston 164 to a crankshaft 124. The crankshaft 124 includes a crankshaft angle in relation to each cylinder assembly 106, defined by the rotational position of the crankshaft 124 and the combustion cycle of the cylinder assembly 106. Referring back to FIG. 1, to sense the crankshaft 124 rotational position, a crankshaft position sensor 126 can be configured to generate a crankshaft position signal indicative of the rotational position of the crankshaft 124.

To lubricate moving parts of the engine 102, the engine 102 can include a lubrication system 127. The lubrication system 127 includes an oil reservoir 128 to accommodate liquid lubricants such a petroleum based oil. An oil pump 130 can draw oil from the oil reservoir 128 through oil channel 132. The oil pump 130 can be driven by the crankshaft 124 through a mechanical link 134 such as gears or belts. In other embodiments the oil pump 130 may be driven by other power sources such as an electric motor (not shown) or a hydraulic motor (not shown). The oil pump 130 may pump oil through an oil gallery and channels 136 to lubricate moving parts of engine 102.

To supply the fuel that the engine 102 burns during the combustion process, a fuel system 138 is operatively associated with the diagnostic system 100. The fuel system 138 includes a fuel reservoir 140 that can accommodate a hydrocarbon-based fuel such as liquid diesel fuel. Because the fuel reservoir 124 may be situated in a remote location with respect to the engine 102, a fuel line 142 can be disposed through the diagnostic system 100 to direct fuel from the fuel reservoir 140 to the engine 102. To pressurize the fuel and force it through the fuel line 142, a fuel pump 144 can be disposed in the fuel line. An optional fuel conditioner 146 may also be disposed in the fuel line 142 to filter the fuel or otherwise condition the fuel by, for example, introducing additives to the fuel, heating the fuel, removing water and the like.

To introduce the fuel to the cylinder assemblies 106, the fuel line 142 may be in fluid communication with one or more fuel injectors 148 that are associated with the cylinder assemblies 106. In the illustrated embodiment, one fuel injector 148 is associated with each cylinder assemblies 106, but in other embodiments a different number of injectors 148 might be used. Additionally, while the illustrated embodiment depicts the fuel line 142 terminating at the fuel injectors 148, the fuel line 142 may establish a fuel loop that continuously circulates fuel through the plurality of injectors 148 and, optionally, delivers unused fuel back to the fuel reservoir 140. Alternatively, the fuel line 142 may include a fuel collector volume or rail (not shown), which supplies pressurized fuel to the fuel injectors 148. The fuel injectors 148 can be electrically actuated devices that selectively introduce a measured or predetermined quantity of fuel to each cylinder assemblies 106.

To coordinate and control the various systems and components associated with the diagnostic system 100, the system 100 can include an electronic or computerized control unit, module, or controller 152. The controller 152 is adapted to monitor various operating parameters and to responsively regulate various variables and functions affecting engine 102 operation. The controller 152 can include a microprocessor, an application specific integrated circuit (ASIC), or other appropriate circuitry, and can have memory or other data storage capabilities. The controller 152 can include functions, steps, routines, data tables, data maps, charts, and the like, saved in, and executable from, read only memory, or another electronically accessible storage medium, to control the diagnostic system 100. Although in FIG. 1, the controller 152 is illustrated as a single, discrete unit, in other embodiments, the controller 152 and its functions may be distributed among a plurality of distinct and separate components. The single unit or multiple component controller 152 may be located on-board the engine 102, a machine powered by the engine 102, and/or in a remote location. Controller 152 can be communicatively linked to cylinder pressure sensors 150 to receive cylinder pressure signals. Controller 152 can be communicatively linked to the crankshaft position sensor 126 to receive the crankshaft position signal. Controller 152 can be communicatively linked to the fuel injectors 148 through communication links 154 to control the timing of and amount of fuel injected during fuel injections into the cylinder assemblies 106. Communication links 154 may relay digital and/or analogue signals between the controller 152 and cylinder pressure sensors 150, the crankshaft position sensor 126, and fuel injectors 148. The communication links 154 may include wires, busses, or other communication links 154 as are known in the art. In some embodiments the communication links 154 may include radio, satellite, and/or telecommunication channels.

Controller 152 can include an end of fuel injection estimation module 156, a fuel injection control module 158, and an oil degradation estimation module 160. For the purposes of this application a module includes lines of executable code, data structures, and/or apparatus (such as transmitters or receivers) to perform a particular function of the controller 152. Although illustrated in FIG. 1 as discreet units, it will be understood by those skilled in the art that the modules may not include physical discreet units, but rather may include a schematic way of illustrating a function and/or logic operation that may be performed by the controller 151 The lines of code and data structure included in a module may or may not be consecutive or contained in a discreet memory unit, and may be shared with other modules. Apparatus may be shared among modules as well.

### INDUSTRIAL APPLICABILITY

Knowing or being able to estimate the crankshaft angle at which the end of a fuel injection event occurs during a combustion cycle of engine 102 can allow the calculation or estimation of other valuable engine 102 parameters, aid in control of some engine 102 functions, and/or provide valuable diagnostic information about the engine 102. For the purposes of this application a fuel injection event includes one or more fuel injections during a combustion cycle of a cylinder assembly 106.

Methods of estimating the end of a fuel injection event known in the art include determining or estimating the end of the fuel injection event as a function of the end of the electrical current supplied to a solenoid in the fuel injector 148 during a combustion cycle. Because the time delay between the end of the electrical current to the fuel injector solenoid and the end of the actual fuel injection event may vary depending on engine operating conditions, this method may introduce too much error to be useful. Also known in the art is bench testing fuel injectors 148 outside the engine 102 and correlating fuel injection signals with the end of the fuel injection event in the engine 102. Because fuel injectors 148 wear during use in the engine, and orifices on the fuel injectors 148 may either narrow or widen due to the wear, this method may also introduce too much error to be useful.

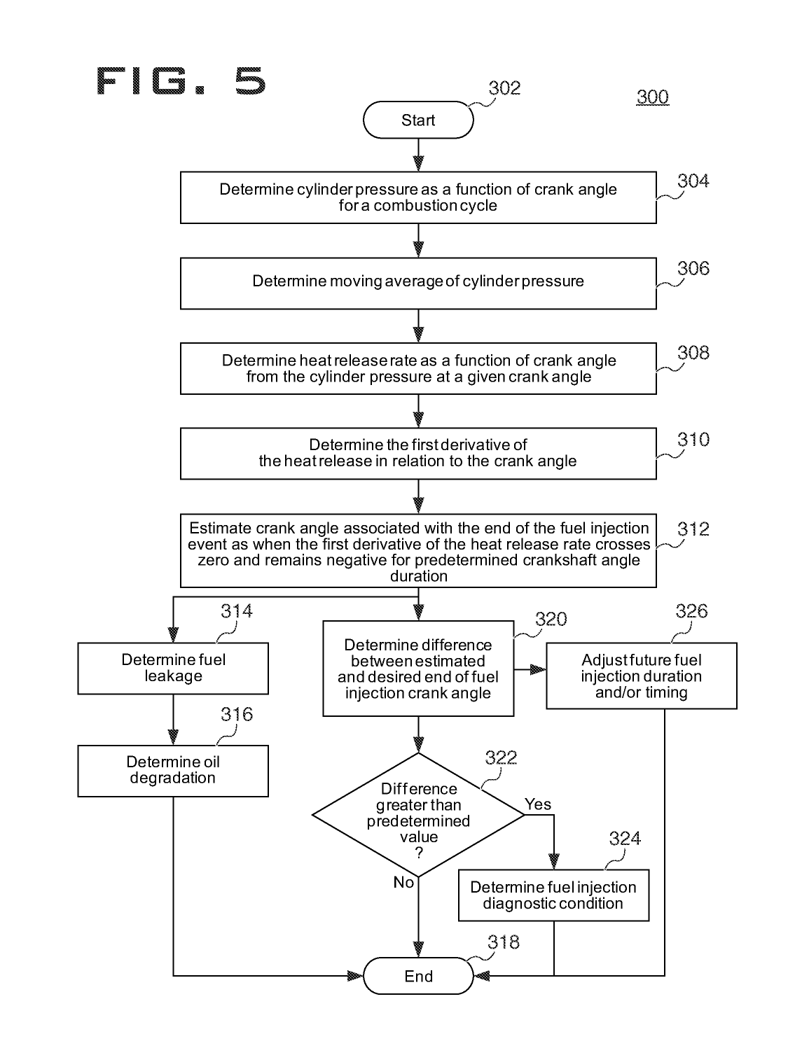

Referring now to FIG. 5, a diagnostic method 300 for a reciprocating internal combustion engine 102 is illustrated. The method 300 includes determining cylinder pressure as a function of crankshaft angle in a combustion chamber of the engine 102 during a combustion cycle, the combustion cycle including a fuel injection event; determining a heat release rate as a function of crankshaft angle in the combustion chamber during the combustion cycle, the heat release rate determined from the cylinder pressure at a given crankshaft angle, and estimating a crankshaft angle associated with an end of the fuel injection event from the first derivative of the heat release rate in relation to the crankshaft angle

The method starts at step 302 and proceeds to step 304. In step 304, a cylinder pressure as a function of crankshaft angle in the combustion chamber 168 of the engine 102 during a combustion cycle is determined. The combustion cycle includes a fuel injection event. Each cylinder assembly 106 includes a combustion cycle as is known in the art. In a four stroke embodiment, the combustion cycle includes an intake stroke, a compression stroke, a power stroke, and an exhaust stroke. During the intake stroke, the crankshaft 124 may rotate one hundred eighty (180) degrees moving the piston 164 from a top dead center position to a bottom dead center position. The intake valves 108 may open just before, at the beginning of, or during the intake stroke drawing air into the combustion chamber 168, and the exhaust valves 116 may remain closed during most or the entire stroke.

During the compression stroke, the crankshaft 124 may rotate one hundred eighty (180) degrees moving the piston to a top dead center position and compressing air in the combustion chamber 168. The intake valves 108 and exhaust valves 116 may be closed during most or the entire compression stroke. Fuel injectors 148 may begin to inject fuel into the combustion chamber 168 during the compression stroke. One or more distinct fuel injections may occur during the compression stroke and the following power stroke. The fuel injection event may include the total fuel injections during the combustion cycle. As the air is compressed and the temperature rises in the combustion chamber 168 the fuel may self-ignite or may be ignited by an ignition device (not shown) such as a sparkplug or a glowplug during the end of the compression stroke or beginning of the power stroke.

During the power stroke, the combusting fuel and air pushes the piston 164 toward the bottom dead center position, rotating the crankshaft 124 one hundred eighty (180) degrees. The intake valves 108 and exhaust valves 116 may be closed during most or the entire power stroke. The injection duration, injection pressure, and volume of the one or more fuel injections of the fuel injection event may vary depending on the load being powered by the engine and the engine 102 speed. The controller 154, and in particular the fuel injection control module 158 may communicate with the fuel injectors 148 to begin and end the fuel injection event.

During the exhaust stroke, the crankshaft 124 may rotate one hundred eighty (180) degrees pushing the piston 164 back toward the top dead center position as is known in the art. The intake valves 108 may remain closed, while the exhaust valves 116 may open, allowing exhaust from the combusted fuel and air to be pushed out of the combustion chamber 168, through the exhaust runners 120, into the exhaust manifold 118, and through the exhaust line 122.

It is known by those skilled in the art to identify a point during the combustion cycle by an associated crankshaft angle. In the above four stroke combustion cycle example, the crankshaft 124 rotates seven hundred twenty (720) degrees. The intake stroke occurs from zero (0) to one hundred eighty (180) degrees. The compression stroke occurs from one hundred eighty (180) to three hundred sixty degrees (360). The power stroke occurs from three hundred sixty (360) to five hundred forty (540) degrees. The exhaust stroke occurs from five hundred forty (540) to seven hundred twenty (720) degrees. It is also known by those skilled in the art to identify the timing of fuel injections of the fuel injection event and other events by the associated crankshaft angle in the combustion cycle.

Other embodiments of combustion cycles are known in the art for reciprocating internal combustion engines 102 and are contemplated as part of the disclosure. For example, the combustion cycle may include a two stroke cycle or a six stroke cycle. Not all cylinder assemblies 106 have directly corresponding combustion cycles. Rather, the combustion cycles of the cylinder assemblies 106 may overlap, producing a more stable and continuous rotational speed of the crankshaft 124. Although generally in the art, points and periods in the combustion cycle are referred to in relation to the crankshaft angle, it is contemplated that parameters related to the crankshaft angle may also be used to define a point or period in the combustion cycle, such as for example, the piston 164 position. Since the piston 164 is operably coupled to the crankshaft 124, through the rod 174, the position of the piston 164 is directly related the crankshaft angle. It is contemplated that a disclosure relating a period or point in the combustion cycle defined by an alternative parameter indicative of the crankshaft angle would also define that period or point in relation to the crankshaft angle.

The cylinder pressure sensor 150 may generate the cylinder pressure signal periodically or continuously during the combustion cycle. The periodic or continuous cylinder pressure signal may be transmitted to the controller 154, and more specifically to the end of fuel injection module 156 via communication links 154. The crankshaft position sensor 126 may generate a crankshaft position signal periodically or continuously as is known in the art. The crankshaft position signal may be transmitted to the controller 154, and more specifically to the end of fuel injection module 156 via communication links 154. The controller 154 may correlate the cylinder pressure signal and the crankshaft position signal and determine a cylinder pressure as a function of crankshaft angle in the combustion chamber 168 pressure during a combustion cycle. The cylinder pressure as a function of crankshaft angle may be a plot of the cylinder pressure verses the crankshaft angle, a table, a series of coded algorithms or equations, or any other data storage technique known in the art. The method 300 proceeds to step 306.

In step 306, a moving average of the cylinder pressure as a function of crankshaft angle may be determined. In some embodiments, and/or in some engine 102 conditions, the cylinder pressure as a function of crankshaft angle relationship may include a great deal of noise. This may be due to noise in the electronics, uneven combustion or other reasons known in the art. A moving average of the relationship may be determined to eliminate part of the noise. The moving average may be a three to five degree moving average. In alternative embodiments, other methods of filtering out noise known in the art may be used. The method 300 proceeds to step 308.

In step 308, a heat release rate as a function of crankshaft angle in the combustion chamber 168 during the combustion cycle is determined. It is well known in the art to determine a heat release rate at a given crankshaft angle in the combustion chamber 168 of an engine 102 from the cylinder pressure as a function of crankshaft angle for a combustion cycle in the combustion chamber 168.

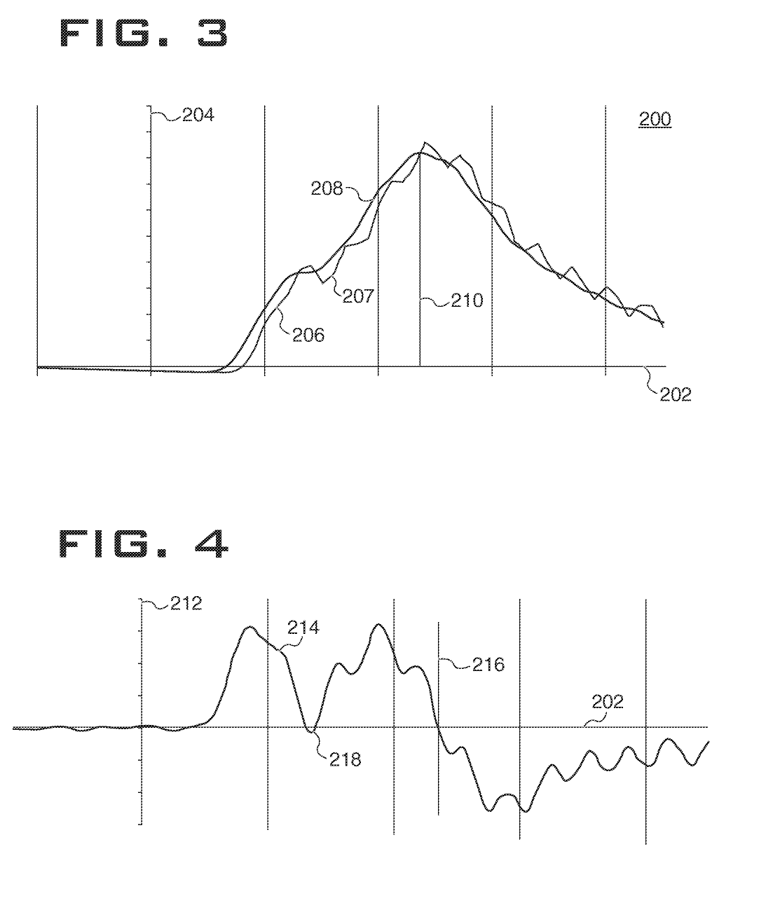

Referring to FIG. 3, an exemplary plot 200 of the heat release rate as a function of crankshaft angle in the combustion chamber 168 of an engine 102 is illustrated. The x-axis 202 represents the crankshaft angle for a portion of the combustion cycle. The y-axis 204 represents the heat release rate. The x-axis 202 and the y-axis 204 cross at the zero points for both axes. Plot 206 represents the heat release rate in the combustion chamber 168 plotted against the crankshaft angle for a portion of the combustion cycle before filtering with a moving average. Plot 208 represents the heat release rate in the combustion chamber 168 plotted against the crankshaft angle for a portion of the combustion cycle after filtering with a moving average. The heat release rate in the combustion chamber 168 peaks and has a zero (0) slope in relation to the crankshaft angle at crankshaft angle 210. The heat release rate also declines for a short duration of crankshaft angle at 207 and then continues to increase. In some embodiments, a decline such as illustrated at 207 may be due to uneven burning of fuel and air in the combustion chamber 168. The method 300 proceeds to step 310.

In step 310, the first derivative of a heat release rate in relation to crankshaft angle for the combustion cycle is determined. Referring to FIG. 4, an exemplary plot of the first derivative of the heat release rate in the combustion chamber 168 of an engine 102 plotted in relation to the crankshaft angle is illustrated. The x-axis 202 represents the crankshaft angle for a portion of the combustion cycle. The y-axis 204 represents the first derivative of the heat release rate in relation to the crankshaft angle. The x-axis 202 and the y-axis 204 cross at the zero points for both axes. Plot 214 represents the first derivative of the heat release rate in the combustion chamber 168 plotted in relation to the crankshaft angle for a portion of the combustion cycle. The first derivative of the heat release rate in the combustion chamber 168 crosses the x-axis at 218 and again at crankshaft angle 216. Crankshaft angle 216 represents where the first derivative of the heat release rate in the combustion chamber 168 crosses the zero axis and then remains negative for a predetermined period of time. As illustrated in FIG. 3, uneven combustion or other events may occur in some engine 102 embodiments leading to a decline and then increase of the heat release rate during a crankshaft angle duration. When the first derivative of the heat release rate in relation to the crankshaft angle is determined, the first derivative of the heat release rate may cross the zero axis (shown at point 218 in FIG. 3) during the crankshaft duration of the uneven combustion (shown at point 207 in FIG. 2). The method 300 proceeds to step 312.

In at least some embodiments of a reciprocating internal combustion engine 102, it has be shown experimentally, that the end of the fuel injection event in the combustion cycle can be estimated within an acceptable margin of error as when the first derivative of the heat release rate in relation to the crankshaft angle equals zero (0) and then stays negative. The end of injection module 156 may estimate that the end of a fuel injection in a combustion cycle occurs at the crankshaft angle where the first derivative of the heat release rate equals zero (0) and then stays negative for a predetermined period of time.

The estimation of the crankshaft angle when the end of the fuel injection occurs (referred to as “end of injection”) may be used in several useful diagnostic methods for the engine 102. For example, the end of injection may be used in calculating the degradation of the engine 102 oil (steps 314, 316, and 318), trimming a fuel injector 148 (steps 320, 326, and 318), and/or determining a diagnostic condition of a fuel injector 148 (steps 320, 322, 324, and 318).

In step 314, a fuel leakage through the fuel leakage channel 170 may be determined. In some fuel injections, the fuel may impact the piston bowl 166 and splash into the fuel leakage channel. Fuel may flow through the fuel leakage channel 170 and into an oil channel, gallery, or reservoir 136, 128 and degrade the oil. The amount of fuel leaking through the leakage channel 170 may be determined as a function of the geometry of the piston bowl 166 and other elements of the cylinder assembly 106, the fuel injection characteristics, and the end of injection. The method 300 proceeds to step 316.

In step 316, the end of fuel injection module 156 may communicate the end of injection to an oil degradation module 160. The oil degradation module 160 may determine the oil degradation at least partially from the end of injection. The oil degradation may be used to predict when oil changes are needed for the engine 102. The method 300 proceeds to step 318 and ends.

In step 320, the difference between a desired end of a fuel injection event, and the end of the fuel injection event as determined by the method described above, may be determined. The end of fuel injection module 156 may communicate to the fuel injection control module 158 the estimated actual end of the fuel injection event. The fuel injection control module 158 may compare this with the desired end of the fuel injection event and determine a difference. The method 300 may proceed to either step 322 or 326.

In step 322, the fuel injection control module 158 may determine if the difference between the desired end of the fuel injection event and the estimated end of the fuel injection event is greater than a predetermined value. If the difference is not greater than the predetermined value, the method 300 proceeds to step 318 and ends. If the difference is greater than the predetermined value, the method 300 proceeds to step 324.

In step 324, the fuel injection control module 158 may determine a fuel injection diagnostic condition and log a fault or other code. The condition, fault, or code, may alert a service technician, operator, and/or owner of the engine 102 or machine the engine 102 is powering that a fuel injector 148 may need service. The method proceeds to step 318 and ends.

In step 326, the fuel injection control module 158 may alter or adjust the duration or timing of the fuel injection event as a function of the difference between the desired end of the fuel injection event and the estimated end of the fuel injection event. During the life of a fuel injector 148, orifices may narrow from deposits such as coke, or they may widen from wear. These changes can cause actual fuel injections to end at times other than expected. This can affect the operation of the engine 102. Signals from the fuel injection control module 158 to the fuel injectors 148 may be altered or adjusted as a function of the difference between the desired and estimated end of the fuel injection event to compensate for narrowing or widening of orifices during the life of the fuel injector 148. The method proceeds to step 318 and ends.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. A diagnostic method for a reciprocating internal combustion engine, comprising:
determining cylinder pressure as a function of crankshaft angle in a combustion chamber of the engine during a combustion cycle, the combustion cycle including a fuel injection event,
determining a heat release rate as a function of crankshaft angle in the combustion chamber during the combustion cycle, the heat release rate determined from the cylinder pressure at a given crankshaft angle, and
estimating a crankshaft angle associated with an end of the fuel injection event from the first derivative of the heat release rate in relation to the crankshaft angle.

2. The diagnostic method of claim 1, wherein the crankshaft angle associated with an end of the fuel injection event is estimated as the crankshaft angle associated with when the first derivative of the heat release rate in relation to the crankshaft angle crosses zero and remains negative for a predetermined crankshaft angle duration.

3. The diagnostic method of claim 1, further including determining the heat release rate as a function of crankshaft angle from a moving average of the cylinder pressure signal during the combustion cycle.

4. The diagnostic method of claim 3, wherein the moving average includes a moving average in the range of three to five degrees.

5. The diagnostic method of claim 1, further including determining engine oil degradation as a function of the crankshaft angle associated with an end of the fuel injection event.

6. The diagnostic method of claim 5, wherein determining engine oil degradation includes determining an amount of fuel leaking into the engine oil during the combustion cycle as a function of the crankshaft angle associated with the end of the fuel injection event, the position of a piston at the crankshaft angle associated with the end of the fuel injection event, and a geometry of the piston.

7. The diagnostic method of claim 1, further including adjusting at least one of the duration and timing of the fuel injection event as a function of the crankshaft angle associated with an end of the fuel injection event.

8. The diagnostic method of claim 7, wherein at least one of the duration and timing of the fuel injection event is adjusted as a function of a difference between the crankshaft angle associated with the end of the fuel injection event and a desired crankshaft angle associated with the end of the fuel injection event.

9. The diagnostic method of claim 1, further including determining a fuel injection diagnostic condition as a function of the crankshaft angle associated with the end of the fuel injection event.

10. The diagnostic method of claim 9, wherein determining a fuel injection diagnostic condition includes determining that a difference between the crankshaft angle associated with the end of the fuel injection event and a desired crankshaft angle associated with the end of the fuel injection event is greater than a predetermined value.

11. A diagnostic system for a reciprocating internal combustion engine, comprising:
a crankshaft including a crankshaft angle,
at least one cylinder assembly including;
a cylinder,
a piston slidingly disposed in the cylinder and operably and rotatably connected to the crankshaft,
a combustion chamber defined by the cylinder and piston,
a cylinder pressure sensor disposed in the combustion chamber and operable to generate a periodic or continuous cylinder pressure signal indicative of a pressure in the combustion chamber, and
a fuel injector configured to generate a fuel injection event in the combustion chamber during a combustion cycle of the engine as a function of a fuel injection signal indicative of the duration and timing of one or more fuel injections during the combustion cycle, and
a controller configured to;
generate the fuel injection signal,
determine a heat release rate as a function of crankshaft angle in the combustion chamber during the combustion cycle from the cylinder pressure signal and the crankshaft position signal during the combustion cycle, and
estimate a crankshaft angle associated with an end of the fuel injection event from the first derivative of the heat release rate in relation to the crankshaft angle.

12. The diagnostic system of claim 11, wherein the controller is configured to estimate the crankshaft angle associated with the end of the fuel injection event as the crankshaft angle when the first derivative of the heat release relationship crosses zero and remains negative for a predetermined crankshaft angle duration.

13. The diagnostic system of claim 11, wherein the controller is configured to determine the heat release rate as a function of crankshaft angle from a moving average of the cylinder pressure signal during the combustion cycle.

14. The diagnostic system of claim 13, wherein the moving a average includes a moving average in the range of three to five degrees.

15. The diagnostic system of claim 11, further including an engine oil system including engine oil, and wherein the controller is configured to determine engine oil degradation as a function of the crankshaft angle associated with the end of the fuel injection event.

16. The diagnostic system of claim 15,
further including a leakage channel fluidly connecting the combustion chamber with the engine oil system, and
wherein the controller is configured to determine an amount of fuel flowing through the leakage channel into the engine oil during the combustion cycle as a function of the crankshaft angle associated with the end of the fuel injection event, the position of the piston at crankshaft angle associated with the end of the fuel injection event, and a geometry of the piston; and determine engine oil degradation as a function of the amount of fuel flowing through the leakage channel into the engine oil during the combustion cycle.

17. The diagnostic system of claim 11, wherein the controller is configured to adjust the fuel injection signal for a future combustion cycles as a function of the crankshaft angle associated with the end of the fuel injection event.

18. The diagnostic system of claim 17, wherein the controller is configured to adjust the fuel injection signal as a function of a difference between the crankshaft angle associated with the end of the fuel injection event and a desired crankshaft angle associated with the end of the fuel injection event.

19. The diagnostic system of claim 11, wherein the controller is configured to determine a fuel injection diagnostic condition as a function of the crankshaft angle associated with the end of the fuel injection event.

20. The diagnostic system of claim 19, wherein the controller is configured to determine the fuel injection diagnostic condition when a difference between the crankshaft angle associated with the end of the fuel injection event and a desired crankshaft angle associated with the end of the fuel injection event is greater than a predetermined value.
